(19) United States
(12) Patent Application Publication
(10) Pub. No.: US 2010/0237627 A1
(43) Pub. Date: Sep. 23, 2010

(54) Vehicle mounted wind powered hydrogen generator

(76) Inventors: Bert Socolove, Howell, NJ (US); Bradley E. Thomsen, SR., Ft. Myers, FL (US)

Correspondence Address: Hollstein Keating Cattell Johnson & Goldstein P.C.;Willow Ridge Executive Office Park, Suite 301, 750 Rt. 73S., Marlton, NJ, 08053, US

(21) Appl. No.: 12/661,436

(22) Filed: Mar. 17, 2010

Related U.S. Application Data
(60) Provisional application No. 61/210,624, filed on Mar. 20, 2009.

(51) Int. Cl. F03D 9/00; F03B 17/04

(52) U.S. Cl. 290/55; 415/916

(57) ABSTRACT

A vehicle mounted wind powered generator has a self-contained housing with an open, forward airflow intake section and a rear airflow exhaust section. The housing is configured to be mounted on the roof of a vehicle by conventional mounting supports. Airflow is directed into the housing where it is constricted in order to increase the airflow velocity past one or more wind turbines. The airflow is then directed through a channel within the housing and is ultimately discharged through the exhaust section. Power generated by the wind turbines is used to create electricity by means of an attached electricity-generating device, e.g. an alternator/generator. The electricity produced operates a hydrogen production system having its components located within the housing of the hydrogen generator. The resultant hydrogen gas is directed to the engine of the vehicle to increase its efficiency and reduce its emissions.

This application claims the benefit of application Ser. No. 61/210,624, filed on Mar. 20, 2009.

### FIELD OF THE INVENTION

The present invention addresses the vehicle, in situ generation of hydrogen gas to assist in powering vehicles, especially those with internal combustion engines. More specifically the present invention relates to a wind turbine mounted on a moving vehicle for converting wind energy into electricity for use in a sonic, electrolysis cell which creates hydrogen gas for use in the engine of a vehicle.

### BACKGROUND OF THE INVENTION

Wind turbines are typically mounted on wind towers in areas known to have high wind velocity. Various configurations of such wind turbines are designed to convert wind energy into electrical power for residential and commercial use. However, among the greatest challenges associated with wind turbines as a reliable source of energy is that they depend on the quantity and quality of the wind, i.e. wind speed must be maintained at a certain minimum velocity to overcome the friction of moving parts of the turbines. Even in the best geographical areas, average wind speeds are only in the range of 18 to 45 miles per hour, speeds which are required for most electrical generators. Despite these challenges, interest remains high around the world to harvest this clean, free, and inexhaustible energy source.

Complicating the issue of alternative energy sources is the overwhelming use of fossil fuels with their associated environmental hazards. Carbon monoxide levels are among the poorest in the United States and the emissions from automobiles are a major cause of this increasing pollution. Automobiles, trucks, and other vehicles give off carbon monoxide, nitrogen oxides, and hydrocarbons, all clearly contributing to the urban smog, rural air pollution, acid rain, and build-up of greenhouse gases into the atmosphere. As a result, various alternatives are being developed as a possible replacements for petroleum-based transportation fuels. One such alternative is the use of hydrogen gas as the main or supplement fuel to vehicle engines.

Current systems have been proposed which produce electricity provided by wind-driven devices to separate water into its elements, hydrogen and oxygen. This process, is called hydrogen gas electrolysis. Gases converted in such electrolysis processes are delivered into vehicle engines to improve combustion. Because hydrogen is a flammable gas and burns at a lower ignition point and at a higher temperature range than gasoline or diesel fuels, the energy it releases in the first phase of the combustion process assists in the combustion of the other fuels in the cylinders of a vehicle's engine.

However, existing wind turbine hydrogen-producing vehicle systems are impractical to use or inefficient in their operation. This is partly due to the fact that transportation vehicles such as automobiles and trucks usually move at moderate to high speed on the open road. This movement generates wind drag, i.e. an approximate opposite and equal head-wind speed relative to the vehicle. The faster a vehicle moves the more wind resistance or wind drag it has to overcome. The prevailing wind force is therefore detrimental to the efficient movement of vehicles. There is no current system which effectively and efficiently utilizes this wind force and the airflow created by vehicle movement to produce hydrogen gas to increase the efficiency and non-pollutant aspect of a vehicle engine.

### SUMMARY OF THE INVENTION

There is thus a need to harness and convert the energy lost to detrimental wind drag into a beneficial source of energy. This is accomplished by the vehicle-mounted wind-powered hydrogen generator of the present invention. This hydrogen generator is configured to mount on a moving vehicle and to capture the otherwise wasted energy and convert it into a useful engine burning component, i.e. hydrogen.

The hydrogen generator of the present invention comprises a self-contained housing with an open, forward airflow intake section and a rear airflow exhaust section. The housing is configured to be mounted on the roof of a vehicle by conventional mounting supports. Airflow is directed into the housing where it is constricted in order to increase the airflow velocity past one or more wind turbines. The airflow is then directed through a channel within the housing and is ultimately discharged through the exhaust section. Power generated by the wind turbines is used to create electricity by means of an attached electricity-generating device, e.g. an alternator/generator. The electricity produced operates a hydrogen production system having its components located within the housing of the hydrogen generator. The resultant hydrogen gas is directed to the engine of the vehicle to increase its efficiency and reduce its emissions.

The hydrogen generator of the present invention permits a vehicle engine to operate on two fuel streams, one of the streams being hydrogen derived from the hydrogen generator, thus providing a second fuel source to the engine at a substantially constant flow.

The hydrogen generator of the present invention has a design which is relatively simple and does not require numerous complex moving parts or more complicated mechanical structures. The cost of fabrication and manufacture would thus be reasonable and thereby permit the installation of the hydrogen generator and conversion of a vehicle to a hydrogen hybrid vehicle at a reasonable cost to the consumer.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the wind powered hydrogen generator of the present invention mounted on the roof of a vehicle.

FIG. 2 is a top view of the wind powered hydrogen generator of the present invention.

FIG. 3 is an elevation view of the wind powered hydrogen generator of the present invention.

FIG. 4 is a rear view of the wind powered hydrogen generator of the present invention.

FIG. 5 is a top view showing the interior of the wind powered hydrogen generator of the present invention.

FIG. 6 is a schematic view showing the operation of the hydrogen producing system contained within the wind powered hydrogen generator of the present invention.

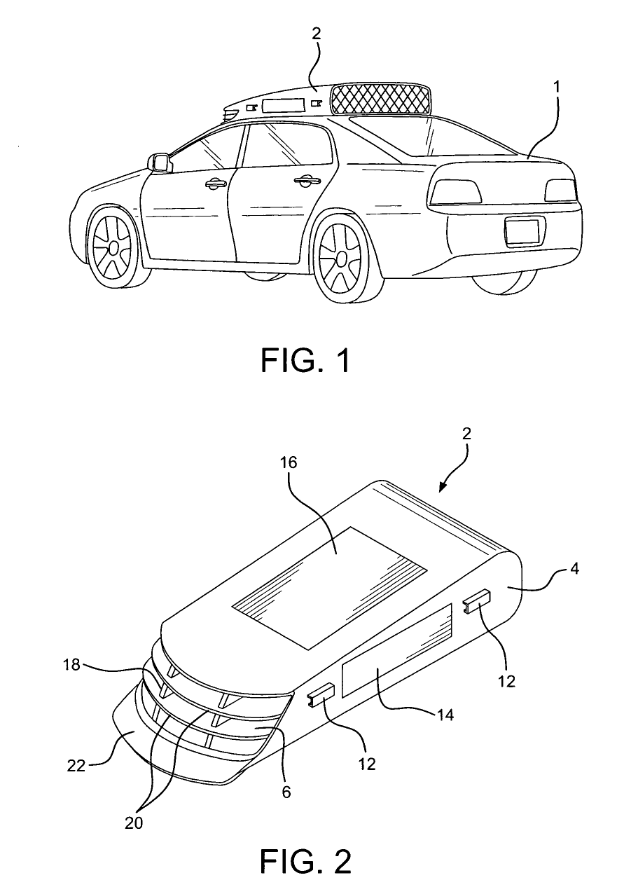

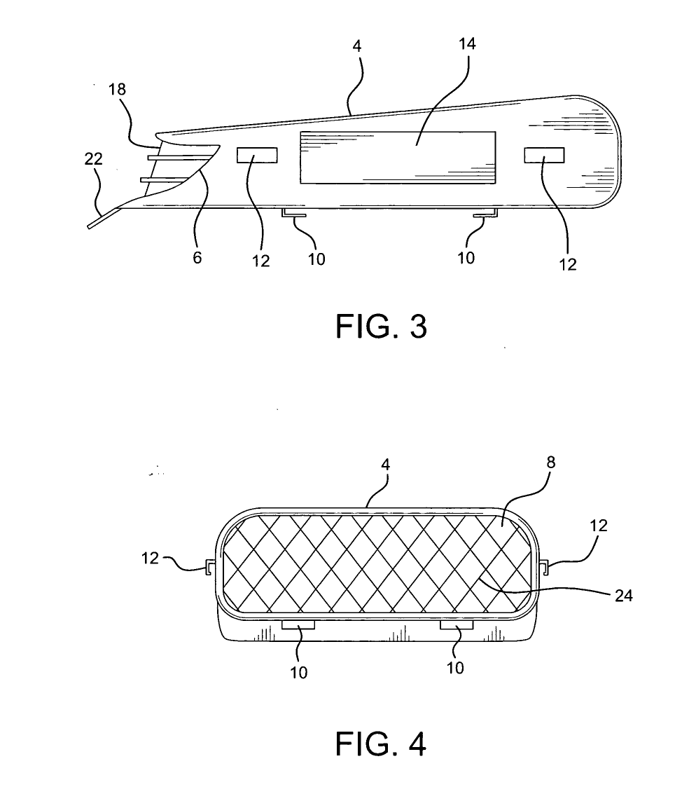

### DETAILED DESCRIPTION OF THE INVENTION

Wind powered hydrogen generator 2 of the present invention is configured to be mounted on the roof of an internal combustion engine propelled vehicle 1. Generator 2 comprises substantially enclosed aerodynamic housing 4, front airflow intake section 6, and rear airflow exhaust section 8. Lower roof mounts 10 and lateral roof mounts 12 are provided for securing generator 2 to a variety of different automobiles, vans, SUVs, etc. Housing 4 includes removeable side panel doors 14 on each side of the housing (only one of the doors is shown in FIG. 2) and removeable top panel door 16 to allow access to the interior of housing 4.

Intake section 6 of housing 4 is generally open, but comprises intake grill 18 with horizontally aligned louvers 20 to direct incoming airflow to the interior of housing 4. Louvers 20 can be adjusted mechanically or electrically to receive optimum airflow or to close the opening of intake section 6, if desired. Forward lip extension 22 extending from the front of housing 4 is provided to ensure smoother airflow into the housing and to prevent air from going between the housing and the roof of the vehicle. Exhaust section 8 is also generally open except for protective outer grill 24.

Air channel 26 extends completely through the interior of housing 4. Intake shroud section 28 is located directly behind intake grill 18 and leads into channel 26. Shroud section 28 comprises angled walls which serve to constrict and force airflow into channel 26.

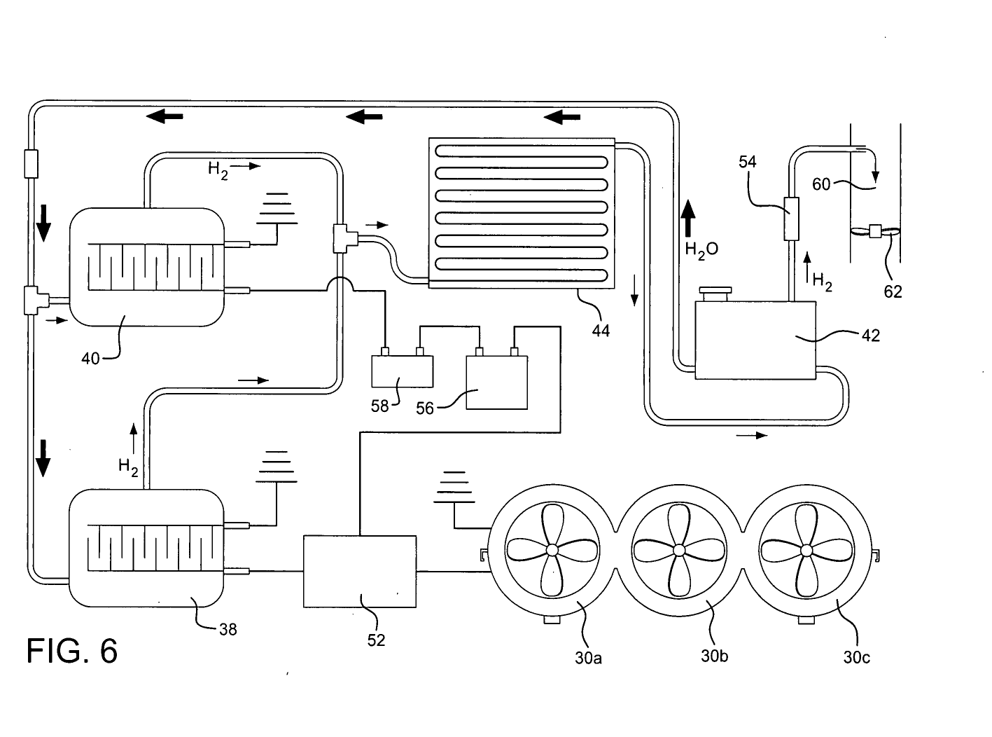

One or more wind turbines 30 (and 30a, 30b, and 30c in FIG. 6) each having multiple blading, are located at the forwardmost position of channel 26, where shroud section 28 terminates. Wind turbine 30 drives an electricity producing device, e.g. generator/alternator 32, which provides the electricity for powering the hydrogen production system utilized in the present invention. To accomplish this, a rotating output shaft from the wind turbine could be connected to an electric generator or alternator either directly or by belts and pulleys, or any equivalent system. The wind turbines 30 may be positioned horizontally, vertically, behind each other, or in the optimum configuration which will result in the most efficient communication with the oncoming airflow. Electricity generated by generator/alternator 32, via wind turbine 30, can also be used to charge batteries of electric propolled automobiles.

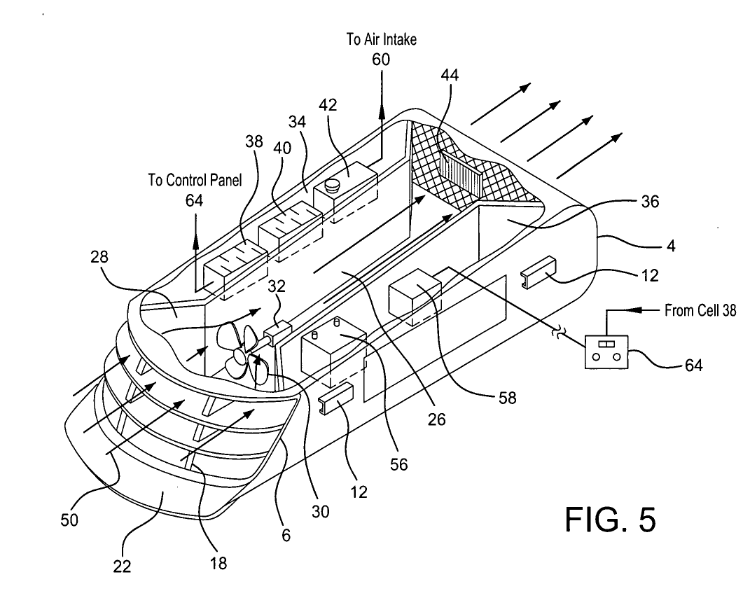

Housing 4 further comprises internal lateral compartments 34 and 36. Enclosed within these compartments are components for the hydrogen production system, i.e. the conversion of water into hydrogen gas for use in assisting in powering the engine of vehicle 1. In the embodiment depicted in FIG. 5, hydrogen gas creating electrolysis cells 38 and 40 of the hydrogen production system are located in lateral space 34, along with the system's water reservoir/bubbler tank 42. Battery 56 and electrical inverter 58 are located in compartment 36. The invention is not to be considered restricted to the placement of these components in housing 4 and any convenient configuration is contemplated. Radiator 44 of the system is positioned adjacent to the opening of exhaust section 8, so as to receive the cooling benefit of airflow discharged out of housing 4.

Hydrogen generator 2 is mounted on the roof of vehicle 1, just above the windshield or at an appropriate location so as to utilize the head-on airflow produced by the forward motion of the vehicle. Head-on airflow 50 enters open intake section 6 where the angled walls of shroud section 28 constrict the airflow within housing 4, thus creating a Venturi effect. That is, when the moving air is forced through the constriction, negative air pressure is developed. There is a resultant increase in kinetic energy and a corresponding increase in the velocity of the airflow. This rapidly moving air is directed towards wind turbine 30, which then drives electricity producing device 32. Airflow generated by wind turbine 30 continues through channel 26 and exits through exhaust section 8 at the back end of housing 4.

The electricity produced by device 32 operates the hydrogen production system, as generally depicted in FIG. 6. Wind turbines 30a, 30b, and 30c provide the power to generate electricity which travels through well-known electricity enhancing and safety components, e.g. diodes, relays, fuses, frequency modulators, 52, to hydrogen creating cells 38 and 40, which are supplied with water (H₂0) from water reservoir/bubbler tank 42. Hydrogen gas (H₂) produced by cells 38 and 40 are directed to radiator 44 where the gas is cooled. The hydrogen gas then bubbles through tank 42 and passes through flame arrestor 54. It is ultimately delivered to the vehicle air intake 60, normally behind the vehicle's air filter, where turbo fan 62 intermixes it with ambient air for use in the vehicle's engine.

The operation of hydrogen generator 2 will, secondarily and in conjunction with the creation of hydrogen gas, maintain rechargeable battery 56 with electricity created by wind turbine 30 when the vehicle is stationary. The electricity created and stored in battery 56 will provide ample electrical power to operate cells 38 and 40, thus always ensuring an uninterrupted supply of hydrogen to the vehicle's engine, when the engine is operable. Electric inverter 58 is provided to change 14 v DC current to 120 v DC current, when hydrogen output from cells 38 and/or 40 is increased.

It is contemplated that hydrogen generator 2 will be operated in conjunction with control panel 64 which would be positioned inside vehicle 1, attached by a wire harness. Control panel 64 may comprise any convenient configuration of electric gauges, switches, and dials conducive to the electrical control and monitoring of hydrogen generator 2.

Certain novel features and components of this invention are disclosed in detail in order to make the invention clear in at least one form thereof However, it is to be clearly understood that the invention as disclosed is not necessarily limited to the exact form and details as disclosed, since it is apparent that various modifications and changes may be made without departing from the spirit of the invention.

1. A vehicle mounted wind powered hydrogen generator for an engine propelled vehicle comprising:
a self-contained housing comprising:
air intake means for receiving airflow produced by the forward movement of a vehicle;
an air channel extending completely through the housing;
wind turbine means for providing energy to drive an electricity-generating device;
outlet means for the discharge of airflow from the channel;
hydrogen production means for the conversion of water into hydrogen;
means to intermix converted hydrogen with air and transmit the mixture to the engine of the vehicle; and
mounting means for removeably securing the housing to the roof of the vehicle.

2. The vehicle mounted wind powered hydrogen generator as in claim 1 wherein the intake means comprises an opening located at the front of the housing and the outlet means comprises an opening located at the rear of the housing.

3. The vehicle mounted wind powered hydrogen generator as in claim 1 wherein the intake means comprises louvers to direct incoming air to the wind turbine means.

4. The vehicle mounted wind powered hydrogen generator as in claim 1 further comprising means to increase the velocity of airflow to the wind turbine means.

5. The vehicle mounted wind powered hydrogen generator as in claim 4 wherein the means to increase the airflow velocity comprises a shroud section located forward of the air channel.

6. The vehicle mounted wind powered hydrogen generator as in claim 1 wherein the wind turbine means comprises at least one fan with a plurality of rotatable blades.

7. The vehicle mounted wind powered hydrogen generator as in claim 1 wherein the hydrogen production means comprises at least one hydrogen generating electrolysis cell located within an enclosed compartment in the housing.

8. The vehicle mounted wind powered hydrogen generator as in claim 7 wherein the hydrogen production means further comprises a water reservoir bubbler tank located within an enclosed compartment in the housing.

9. The vehicle mounted wind powered hydrogen generator as in claim 8 wherein the hydrogen production means further comprises a radiator adjacent to the outlet means.

10. The vehicle mounted wind powered hydrogen generator as in claim 1 further comprising battery means located within the housing for providing electricity to the hydrogen production means when the vehicle on which the hydrogen generator is mounted is stationary.

11. The vehicle mounted wind powered hydrogen generator as in claim 1 wherein the means to intermix the hydrogen with air comprises an intake turbo.

12. An engine propelled vehicle having a roof of the vehicle and front windshield, said vehicle comprising:
a hydrogen generator mounted on the roof of a vehicle and rearward of the windshield of the vehicle, said hydrogen generator comprising:
a self-contained housing comprising:
air intake means for receiving airflow produced by the forward movement of the vehicle;
an air channel extending completely through the housing;
wind turbine means for providing energy to drive an electricity-generating device;
outlet means for the discharge of airflow from the channel;
hydrogen production means for the conversion of water into hydrogen;
means to intermix converted hydrogen with air and transmit the mixture to the engine of the vehicle; and
mounting means for removeably securing the housing to the roof of the vehicle.

13. The vehicle as in claim 12 wherein the intake means comprises an opening located at the front of the housing and the outlet means comprises an opening located at the rear of the housing.

14. The vehicle as in claim 12 wherein the intake means comprises louvers to direct incoming air to the wind turbine means.

15. The vehicle as in claim 12 further comprising means to increase the velocity of airflow to the wind turbine means.

16. The vehicle as in claim 15 wherein the means to increase the airflow velocity comprises a shroud section located forward of the air channel.

17. The vehicle as in claim 12 wherein the wind turbine means comprises at least one fan with a plurality of rotatable blades.

18. The vehicle as in claim 12 wherein the hydrogen production means comprises at least one hydrogen generating electrolysis cell located within an enclosed compartment in the housing.

19. The vehicle as in claim 18 wherein the hydrogen production means further comprises a water reservoir bubbler tank located within an enclosed compartment in the housing.

20. The vehicle as in claim 19 wherein the hydrogen production means further comprises a radiator adjacent to the outlet means.

21. The vehicle as in claim 12 further comprising battery means located within the housing for providing electricity to the hydrogen production means when the vehicle on which the hydrogen generator is mounted is stationary.

22. The vehicle as in claim 12 wherein the means to intermix the hydrogen with air comprises an intake turbo.
